(19) United States
(12) Patent Application Publication
(10) Pub. No.: US 2016/0114425 A1
(43) Pub. Date: Apr. 28, 2016

(54) Method for Manipulating Microstructure and Grain Size in Laser Three-Dimensional Additive Manufacturing

(71) Applicant: Jian Liu, San Jose, CA (US)

(72) Inventor: Jian Liu, San Jose, CA (US)

(21) Appl. No.: 14/985,828

(22) Filed: Dec. 31, 2015

Related U.S. Application Data
(63) Continuation-in-part of application No. 14/324,066, filed on Jul. 3, 2014.

(51) Int. Cl. B23K 26/0622; B23K 26/00; B23K 26/144; C03B 19/01; B23K 26/064; B23K 26/082; B28B 1/00; B23K 26/342; B22F 1/00

(52) U.S. Cl. CPC B23K 26/0624; B23K 26/342; B23K 26/0006; B23K 26/144; B22F 1/0003; B23K 26/064; B23K 26/082; B28B 1/001; C03B 19/01; B23K 2203/52

(57) ABSTRACT

Methods for modifying microstructure and grain size in three-dimensional additive manufacturing are disclosed, including generating electromagnetic radiation from an ultrafast laser, wherein the electromagnetic radiation comprises a wavelength, a pulse repetition rate, a pulse width, a pulse energy, and an average power; focusing the electromagnetic radiation into a focal region; using a powder delivery system to deposit one or more powders at the focal region of the electromagnetic radiation; and adjusting the pulse width, the pulse energy, and the average power of the ultrafast laser to modify the microstructure and grain size of an additively manufactured sample; wherein the average microstructure and grain size increases as the pulse width is increased and wherein the density of the additively manufactured sample increases as the pulse energy is decreased. Other embodiments are described and claimed.

### I. CROSS REFERENCE TO RELATED APPLICATIONS

The application is a continuation-in-part application of U.S. patent application Ser. No. 14/324,066, titled “Method and Apparatus for Three-Dimensional Additive Manufacturing with a High Energy High Power Ultrafast Laser”, filed Jul. 3, 2014, the contents of which is hereby incorporated by reference.

### II. BACKGROUND

The invention relates generally to the field of three-dimensional additive manufacturing. More particularly, the invention relates to a method and apparatus for modifying or manipulating microstructures and grain size in additive manufacturing of materials (metals, ceramics, glasses, semiconductors) with a pulsed laser.

### III. SUMMARY

In one respect, disclosed is a method for modifying microstructure and grain size in three-dimensional additive manufacturing, the method comprising: generating electromagnetic radiation from an ultrafast laser, wherein the electromagnetic radiation comprises a wavelength, a pulse repetition rate, a pulse width, a pulse energy, and an average power; focusing the electromagnetic radiation into a focal region; using a powder delivery system to deposit one or more powders at the focal region of the electromagnetic radiation; and adjusting the pulse width, the pulse energy, and the average power of the ultrafast laser to modify the microstructure and grain size of an additively manufactured sample to meet the desired properties (mechanical, physical, electrical, chemical, and/or biological). For example, mechanical strength is inversely proportional to grain size. Additionally, the microstructure also has a direct impact on the cracks and fatigue of the additively manufactured samples.

In another respect, disclosed is a method for modifying microstructure and grain size in three-dimensional additive manufacturing, the method comprising: generating electromagnetic radiation from an ultrafast laser, wherein the electromagnetic radiation comprises a wavelength, a pulse repetition rate, a pulse width, a pulse energy, and an average power; focusing the electromagnetic radiation into a focal region; using a powder delivery system to deposit one or more powders at the focal region of the electromagnetic radiation; and adjusting the pulse width, the pulse energy, and the average power of the ultrafast laser to modify the microstructure and grain size of an additively manufactured sample; wherein the average microstructure and grain size increases as the pulse width is increased and wherein the density of the additively manufactured sample increases as the pulse energy is decreased.

Numerous additional embodiments are also possible.

### IV. BRIEF DESCRIPTION OF THE DRAWINGS

Other objects and advantages of the invention may become apparent upon reading the detailed description and upon reference to the accompanying drawings.

FIG. 1 is a graph of the finite-difference model of temperature versus exposure for various pulse repetition rates, in accordance with some embodiments.

FIG. 2 is a graph of lattice temperature of fs laser process at different fluence of single pulse, in accordance with some embodiments.

FIG. 3 is a schematic illustration of an apparatus for modifying microstructure and grain size in three-dimensional additive manufacturing, in accordance with some embodiments.

FIG. 4 a schematic illustration of a powder delivery system for an apparatus for modifying microstructure and grain size in three-dimensional additive manufacturing, in accordance with some embodiments.

FIG. 5 is a close-up of the melting of the powder of the fabrication powder bed of FIG. 4, in accordance with some embodiments.

FIG. 6 is a photograph of a tungsten sample made from the apparatus for modifying microstructure and grain size in three-dimensional additive manufacturing of FIG. 3, FIG. 4, and FIG. 5, in accordance with some embodiments.

FIG. 7 shows microscope images at 10× of the top layer of a tungsten sample and their respective ImageJ images for pulse widths of 800 fs, 20 ps, 200 ps, CW, and the substrate, in accordance with some embodiments.

FIG. 8 shows microscope images at 10× of the cross section of a tungsten sample and their respective ImageJ images for pulse widths of 800 fs, 20 ps, 200 ps, CW, and the substrate, in accordance with some embodiments.

FIG. 9 is a photograph of a porous tungsten sample made from the apparatus for modifying microstructure and grain size in three-dimensional additive manufacturing of FIG. 3, FIG. 4, and FIG. 5, in accordance with some embodiments.

FIG. 10 is a photograph of a high density tungsten sample made from the apparatus for modifying microstructure and grain size in three-dimensional additive manufacturing of FIG. 3, FIG. 4, and FIG. 5, in accordance with some embodiments.

FIG. 11 is an SEM of the cross section of a tungsten sample made from the apparatus for modifying microstructure and grain size in three-dimensional additive manufacturing of FIG. 3, FIG. 4, and FIG. 5 resulting from selective laser melting of tungsten powder, in accordance with some embodiments.

FIG. 12 is a block diagram illustrating a method for modifying microstructure and grain size in three-dimensional additive manufacturing, in accordance with some embodiments.

While the invention is subject to various modifications and alternative forms, specific embodiments thereof are shown by way of example in the drawings and the accompanying detailed description. It should be understood, however, that the drawings and detailed description are not intended to limit the invention to the particular embodiments. This disclosure is instead intended to cover all modifications, equivalents, and alternatives falling within the scope of the present invention as defined by the appended claims.

### V. DETAILED DESCRIPTION

One or more embodiments of the invention are described below. It should be noted that these and any other embodiments are exemplary and are intended to be illustrative of the invention rather than limiting. While the invention is widely applicable to different types of systems, it is impossible to include all of the possible embodiments and contexts of the invention in this disclosure. Upon reading this disclosure, many alternative embodiments of the present invention will be apparent to persons of ordinary skill in the art.

Additive manufacturing (AM) is gaining great interest now that many industrial metals like titanium and aluminum are used in established AM processes. However, some challenges still remain.

One challenge is in the production of micro parts. Currently, parts with a resolution of 35 μm can be made from tungsten using continuous wave (CW) fiber laser micro sintering as reported by P. Regenfuss, R. Ebert, and H. Exner, in “Laser Micro Sintering: a Versatile Instrument for the Generation of Microparts.” (Laser Technik Journal, Vol. 4, Issue 1, Pages 26-31, January 2007) These micro parts are being used as micro-engines in micro-satellites to maneuver the satellites while in orbit and in micro-robots to propel the robots. Unlike bulk engines, which can be assembled by several separated components, micro-engines are sized from millimeters to a few centimeters and thus have to be made as a single piece with high resolution at the micron level. Additionally, since the engines are composed of various types of materials (e.g. steel, nickel, titanium), complex structure, and shapes, especially irregular shapes, the use of conventional methods of scaling down in size while keeping the desired performance and robustness (e.g. stress, tension, strength, fatigue, thermal cycling, thrust) is limited. The use of CW lasers for machining micro parts can only go so far since CW lasers produce a heat affected zone (HAZ) which limits the process resolution and quality, such as strength and surface roughness, of micro-sized parts. A post process is usually required to try to alleviate some of these shortcomings, but this in turn further limits the miniaturization of micro devices such as engines.

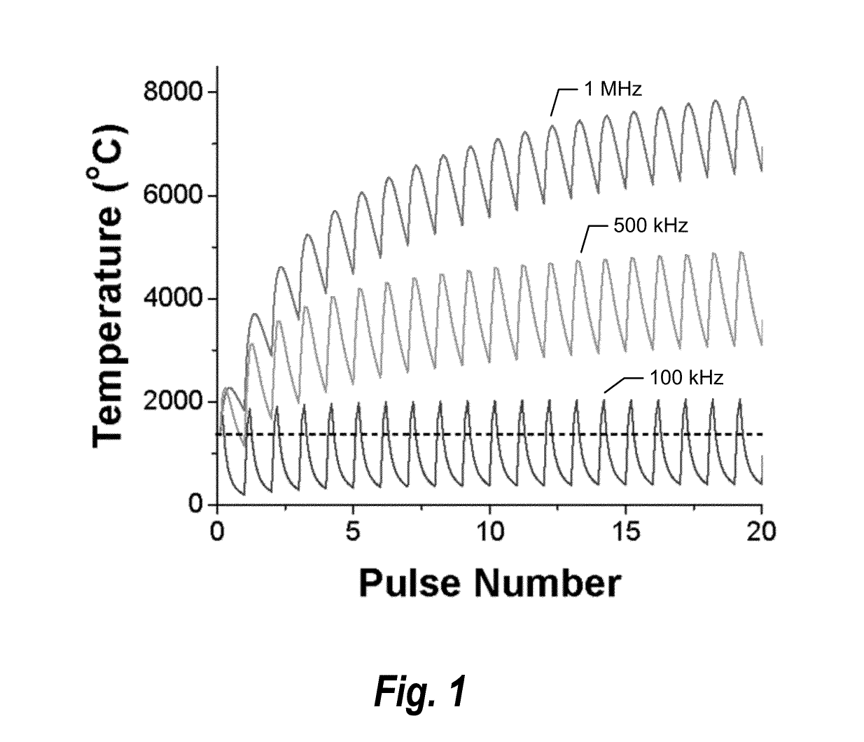

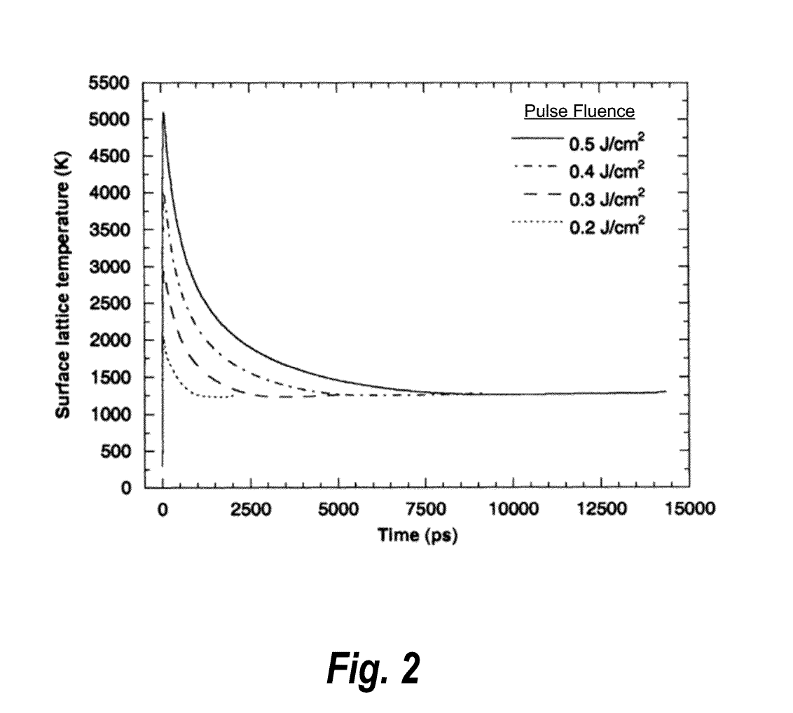

Another challenge is in the production of high temperature metal parts. To date, the majority of AM technology development has focused on conventional structural materials such as titanium and steel. The use of AM technology to refractory metal alloy components, such as tools to work metals at high temperatures, wire filaments, rocket/airplane engines and nozzles, casting molds, and chemical reaction vessels in corrosive environments for example, holds even greater potential to drive affordability given the high raw material costs and complex processing methods associated with such refractory metal alloy products. Refractory metals are a class of metals that are extraordinarily resistant to heat and wear, are chemically inert, and have a relatively high density. The expression “refractory metals” is mostly used in the context of materials science, metallurgy, and engineering. Even so, the definition of which elements belong to the “refractory metals” group differs. The most common definition includes five elements: two of the fifth period (niobium and molybdenum) and three of the sixth period (tantalum, tungsten, and rhenium). Refractory metals all share some properties, including a melting point above 2000° C. and high hardness at room temperature. The melting points of niobium, molybdenum, tantalum, tungsten, and rhenium, are 2750° C., 2896° C., 3290° C., 3695° C., and 3459° C., respectively. As a reference, titanium and aluminum have melting points of roughly 1,650° C. and 650° C., respectively. The high melting points of refractory metals make powder metallurgy complicated for fabricating components from these metals. CW or long pulse (>ns) mode laser processing can only heat the metals to 1500° C. normally, which is the base line of the plots shown in FIG. 1 and FIG. 2. FIG. 1 is a graph of the finite-difference model of temperature versus exposure for various pulse repetition rates, in accordance with some embodiments. FIG. 2 is a graph of lattice temperature of fs laser process at different fluence of single pulse, in accordance with some embodiments. So, for refractory metals or ceramics with melting temperatures over 2000° C., CW laser additive manufacturing is a difficult or impossible process.

A third challenge is in the production of ceramic parts. Ultra high temperature ceramics (UHTCs), such as hafnium (Hf) and zirconium (Zr) based diboride (HfB₂ and ZrB₂), titanium carbide (TiC), titanium nitride (TiN), thorium dioxide (ThO₂), silicon carbide (SiC), tantalum carbide (TaC) and their associated composites, have melting temperatures of over 3000° C. Thus, similar to that of refractory metals, CW or long pulse (>ns) laser AM processing is not possible for melting and bonding.

Additionally, one important issue of AM that has been ignored for a long time by industry is how to modify the microstructure and grain size. The microstructure and grain size directly impact the mechanical performance of the parts made by AM. It has been taken for granted that the microstructure and grain size are “as is” features and cannot be manipulated or managed.

Given these challenges and issues, methods are needed for managing, controlling, modifying, and/or manipulating the microstructure and grain size during the AM process. The methods and apparatuses of the invention described herein may solve these shortcomings as well as others by proposing a novel method for modifying microstructure and grain size in three-dimensional additive manufacturing. By adjusting the pulse width (major parameter from 100 fs to 1 ns, or CW) in association with other parameters (pulse repetition rate, pulse energy, and average power), the microstructure and grain size can be controlled to form desired patterns and orientations.

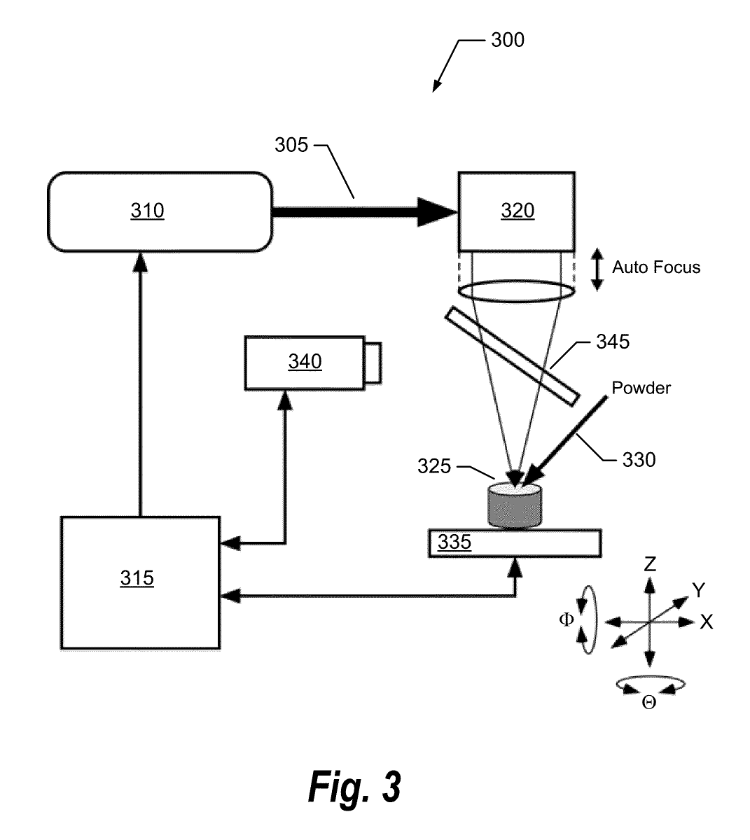

FIG. 3 is a schematic illustration of an apparatus for modifying microstructure and grain size in three-dimensional additive manufacturing, in accordance with some embodiments.

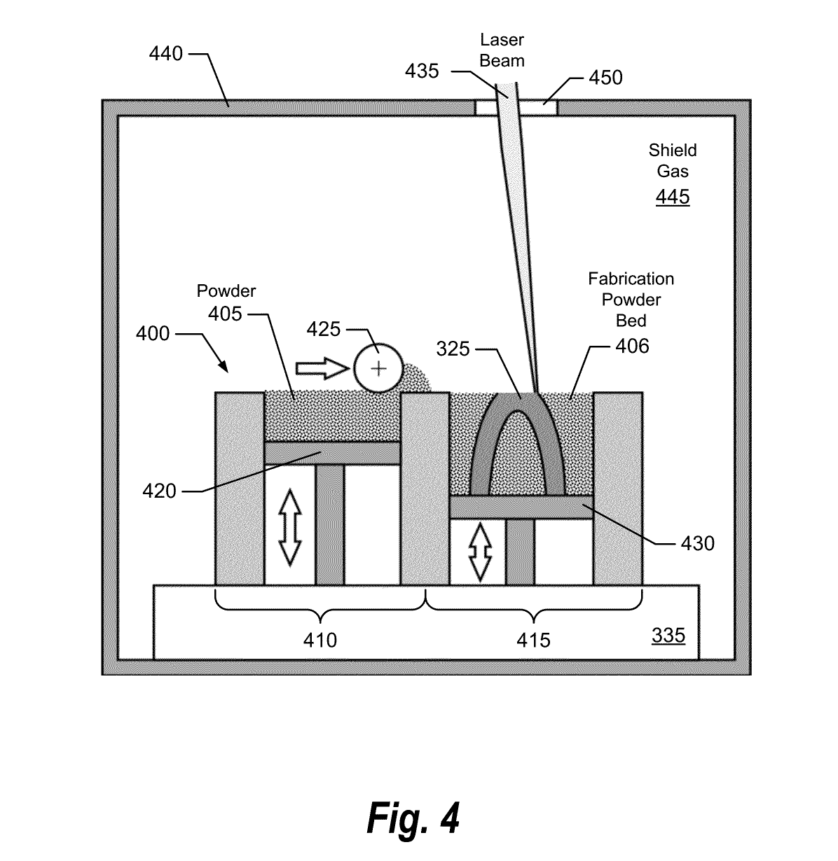

FIG. 4 a schematic illustration of a powder delivery system for an apparatus for modifying microstructure and grain size in three-dimensional additive manufacturing, in accordance with some embodiments.

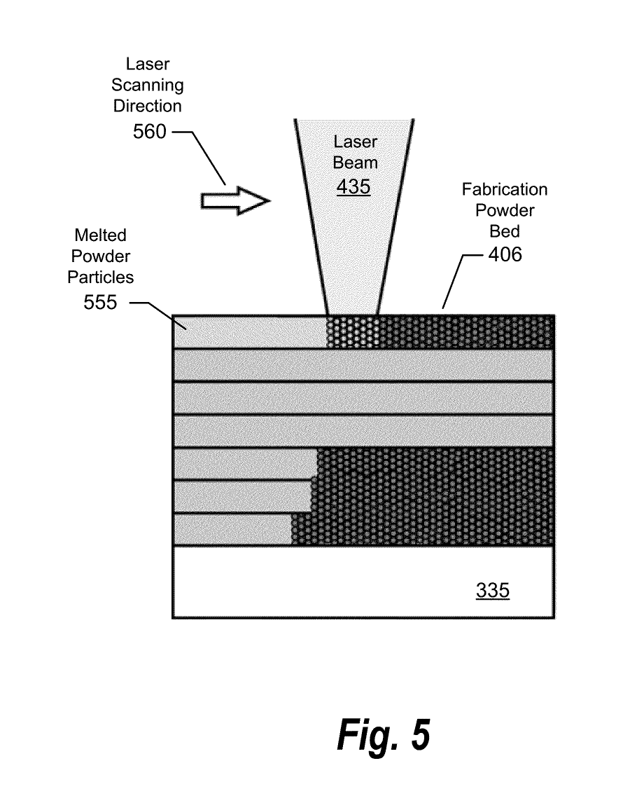

FIG. 5 is a close-up of the melting of the powder of the fabrication powder bed of FIG. 4, in accordance with some embodiments.

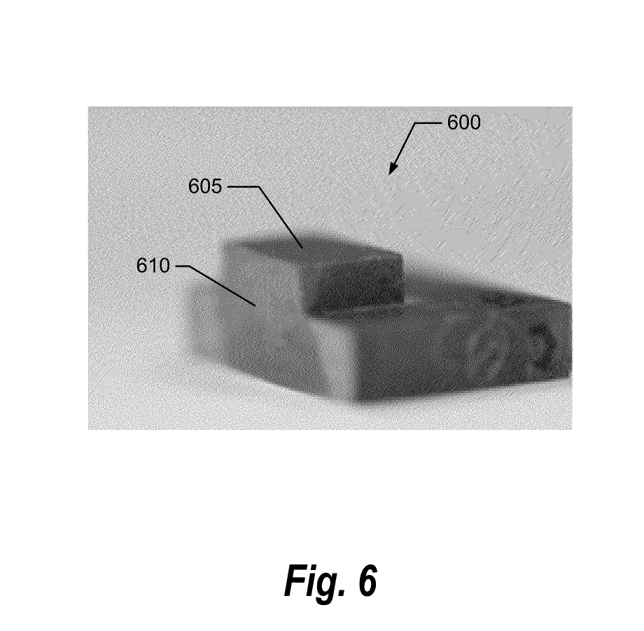

FIG. 6 is a photograph of a tungsten sample made from the apparatus for modifying microstructure and grain size in three-dimensional additive manufacturing of FIG. 3, FIG. 4, and FIG. 5, in accordance with some embodiments.

In some embodiments, the novel method for modifying microstructure and grain size in three-dimensional additive manufacturing is accomplished using apparatus 300 which comprises a high energy, high power laser pulse 305 generated by a high pulse repetition rate fs laser 310. In some embodiments, the laser 310 is a fiber laser. The high energy, high power laser may also be a thin disk laser or a hybrid fiber laser/thin disk laser. The laser will have a PRR from about 0.1 MHz up to 1 GHz, an average power of about 1 to 2000 W, a pulse width of about 0.1 ps to 1 ns, an energy from about 0.1 μJ to 30 mJ, and a wavelength between about 0.2 to 3 p.m. Ideally, it should have diffraction limited beam quality (single mode), but in practice, it can be multi-mode as well. The small spot size allows for precise focusing of fs pulses with excellent beam quality (nature of fiber laser) which is favorable for micro-scale AM processes. Examples of ultrafast fiber lasers include but are not limited to ytterbium (Yb) doped fiber laser at 1025-1100 nm and its harmonic generations to green and UV, erbium (Er) doped fiber laser at 1025-1610 nm and its harmonic generations, thulium (Tm) doped fiber laser at 1950-2050 nm, holmium (Ho) doped fiber laser at 2050-2150 nm, and Er:ZBLAN fiber lasers at 2700-2900 nm. Examples of thin disk lasers include but are not limited to potassium gadolinium tungstate (KGW) or potassium yttrium tungstate (KYW) based lasers (1030-1070 nm) and its harmonic generations (green and UV). Examples of hybrid fiber laser/thin disk laser include using fs fiber laser as a seeding laser for a thin disk amplifier to obtain both high energy and high power fs lasers.

In some embodiments, a computer 315 is first used to convert an AutoCAD or SolidWorks design to 3D printing procedures and contours. The conversion may also been done on some external computing device that is not part of the apparatus. The computer 315 is used to control the PRR, to generate a group of burst mode pulses, to shape grouped micro and macro pulses in amplitude and temporal separation (Macro pulse PRR), to control the power of the laser 310, and to coordinate the scanner 320, to control the powder delivery system, and to control the linear and rotary motorized stages 335. In some embodiments, the high energy, high power pulse 305 is coupled into an auto focusing scanner 320 which scans and focuses the pulse 305 onto the sample 325 being manufactured from the powder 330 being deposited on the stage at first and then subsequent layers of the sample 325, resulting in a strong weld/bond between the sample and the powder. Beam shaping optics positioned between the ultrashort pulse laser and the focusing mechanism may also be used to modify the beam from Gaussian shape to flat top (square or round). The sample 325, may be positioned using its own linear and rotary motor stages 335, in X, Y, Z, Θ, and Φ. The linear and rotary motor stages 335 may be controlled by the computer 315. An imager and processor 340, such as a CCD, may also be controlled by the computer 315. The imager and processor 340 monitors the samples through a dichroic filter 345 as the sample 325 is being additively manufactured. The scanner 320 may be an acousto-optic type scanner (diffraction), a magnetic resonant scanner, a mechanical scanner (rotating mirror), or an electro-optic scanner, etc.

At the beginning of the AM process, similar or dissimilar metal powders are welded/bonded together to start the manufacture of the sample. Sample 325 can be either a pre-manufactured bulk part or powder. The additive manufacturing involves localized heating and is HAZ free since the micro-bond is accomplished by precise focusing of the ultrafast fs pulses on the joining interface of the sample and the powder. The resulting high peak intensity in the focal region ionizes the material of the sample and the powder and creates hot plasma at the interface with limited to no impact on the surrounding area (i.e., HAZ free). As the molten pool (resulting from temperatures going to over 5,000° C.) is localized and quickly built up only in the vicinity of the focus, the thermal stress and thermally induced cracks are largely suppressed. As a result of the nonlinear absorption around the focal volume of the laser pulses, the high energy, high power fs laser system can achieve highly space-selective joining with sub-micron spatial resolution resulting in a stable sub-micron powder bonding, thus offering a higher degree of design flexibility. Additionally, within an ultrashort period, the localized heating helps form stable phase structure and small grain size. As an example, bonding between nickel titanium (NiTi) and stainless steel using a high energy, high power fs laser system forms a stable single phase supersaturated β-Ti(Fe) structure.

In some embodiments, reduced directionality of the additive manufacturing may be achieved by using circularly polarized high energy, high power fs laser pulses scanned quickly and rotationally (wobble function) in micron scale onto the joining interface between the sample being manufactured and the injected powder. Doing so may break the directionality of dendritic structures, thus making the sample robust against mechanical and thermal stresses in all directions.

Specifically, in micro-device AM, a microscopic lens (high NA, >0.5 for example) may be used to create sub-micron size focal beam along beam shaping technique. The focal spot size in air for the laser beam can be calculated by 1.22*λ/N.A., where) is the laser wavelength and N.A. is the numerical aperture of the objective lens. The method described in U.S. Pat. No. 8,675,193 (Near-field material processing system, Mar. 18, 2014) can also be used to make smaller 3D AM devices down to a few nanometers.

In some embodiments, the novel method for modifying microstructure and grain size in three-dimensional additive manufacturing is accomplished using powder delivery system 400 placed onto the stage 335 of FIG. 3 for AM of the sample 325. The powder delivery system 400 comprises the powder 405 loaded into a powder vessel 410 placed adjacent to a receptacle 415 where the sample is fabricated. The powder vessel 410 has a powder delivery piston 420 that raises the level of the powder above the lip of the powder vessel. Next, a roller 425 moves the raised powder into the adjacent receptacle 415 and spreads the powder 405 into a smooth even layer. At the beginning of the AM, the fabrication powder bed 406 is first spread over a fabrication piston 430. After this first layer has been melted, the fabrication piston 430 is lowered and another layer of the powder 405 is uniformly spread into the fabrication powder bed 406 and over the just sintered layer for layer-by-layer fabrication. In some embodiments, at least the first layer is not sintered, thus providing a thermal barrier between the powder layer that is first melted and the fabrication piston 430. In the embodiment illustrated in FIG. 4 and FIG. 5, the laser beam 435 selectively melts the powder which has been uniformly spread into the receptacle 415. The laser beam 435 is scanned in the direction 560 over the fabrication powder bed 406 and results in melted powder particles 555. Since the temperature created by the ultrafast laser can be over the melting temperature of the powder, the powder is completely melted. For each specific powder, the laser parameters (energy, pulse width, pulse repetition rate average power, wavelength, etc.), the scanner speed, powder size and shape, and focal spot size are optimized to generate a temperature larger than the melting temperature of the powder, but lower than the boiling temperature of the powder. The powder 405 may comprise one or more different powder materials. The one or more different powder materials may comprise aluminum, steel, stainless steel, titanium, and the refractory metals, niobium, molybdenum, tantalum, tungsten, and rhenium. The one or more different powders may also comprise ceramics such as hafnium (Hf) and zirconium (Zr) based diboride (HfB₂ and ZrB₂), titanium carbide (TiC), titanium nitride (TiN), thorium dioxide (ThO₂), silicon carbide (SiC), tantalum carbide (TaC) and their associated composites. The one or more different powders may also comprise glasses and crystals such as fused silicon, BK7, quartz, diamond, grapheme, sapphire, and others. The one or more different powders may also comprise semiconductors such as silicon, germanium, GaAs, etc. The powder size of the material ranges from about 1 micron to 200 microns. The powder shape of the material is preferably a round sphere shape. In some embodiments, the stage 335 with the powder delivery system 400 is enclosed in a chamber 440 filled with a shield gas 445 such as argon, helium, nitrogen, and/or hydrogen to help the sample avoid oxidation and chemical reaction or interaction with air. The ionization potentials for argon and helium are 15.7 eV and 24.5 eV. In this embodiment, the chamber has a window 450 where the laser beam 435 passes through the walls of the chamber 440 and onto the fabrication powder bed 406 in the receptacle 415. In an alternative embodiment, the chamber only substantially encloses the powder delivery system and not the stage. In this embodiment, the chamber and the powder delivery system both sit on the stage. The novel method for modifying microstructure and grain size in three-dimensional additive manufacturing additive manufacturing may be performed onto any size and shape substrate using the apparatuses illustrated in FIG. 3, FIG. 4, and FIG. 5. FIG. 6 is a photograph of a tungsten sample 600 made using the apparatus illustrated in FIG. 3, FIG. 4, and FIG. 5. The tungsten sample 600 has a top layer 605 and has been cut to expose its cross section 610.

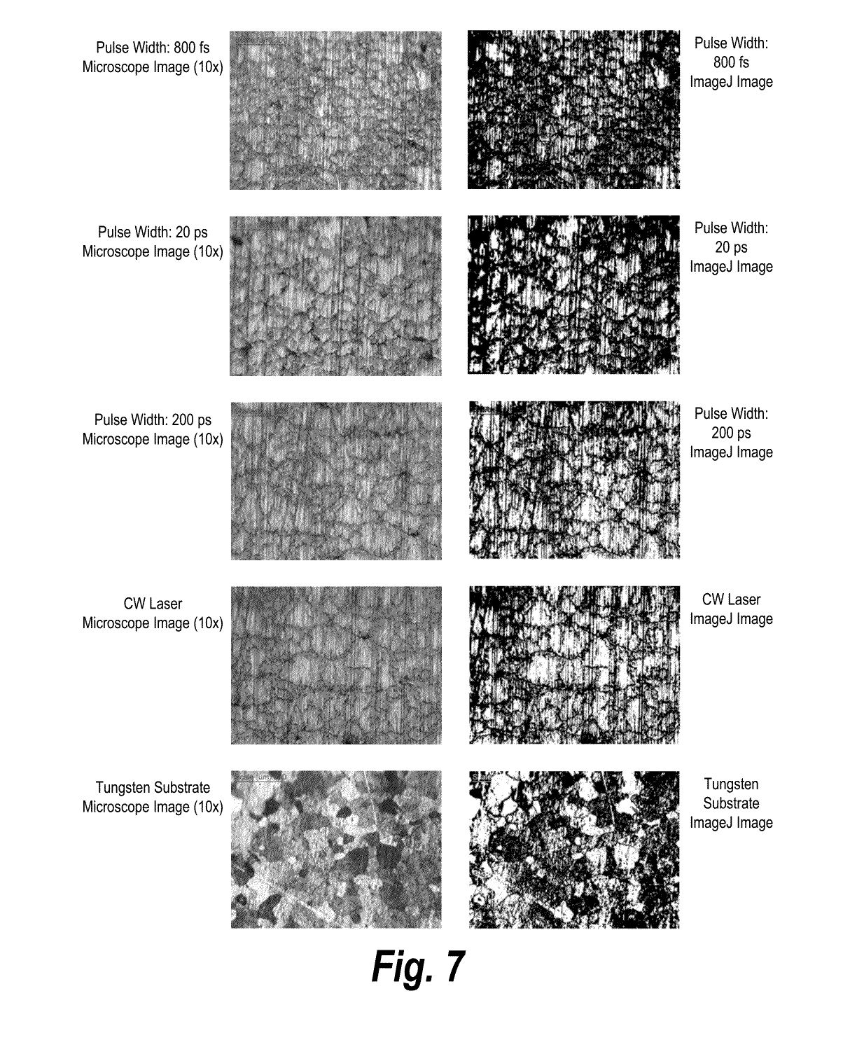

FIG. 7 shows microscope images at 10x of the top layer of a tungsten sample and their respective ImageJ images for pulse widths of 800 fs, 20 ps, 200 ps, CW, and the substrate, in accordance with some embodiments.

Tungsten samples were manufactured using the apparatuses illustrated in FIG. 3, FIG. 4, and FIG. 5 using laser pulse widths of 800 fs, 20 ps, and 200 ps. A CW laser was also used to manufacture one sample. After being manufactured, the tungsten samples were polished and then etched for 3 minutes by a solution comprising 1 g NaOH and 1 g K₃Fe(CN)₄ dissolved in 10 mL of water. Next the samples were rinsed with water followed by a rinse with alcohol and subsequently dried resulting in samples similar to the one shown in FIG. 6. A 10× microscope image was taken of the top layer of each of the samples as well as of the tungsten substrate. The five 10× microscope images of the top layer are shown and labeled in FIG. 7. Using ImageJ, which is an open source image processing program, the boundaries and outlines of the grain sizes were highlighted and an average grain size area of the top layer was calculated. Table I lists the calculated average grain size area of the top layer for the different samples and the five 10× ImageJ images are shown and labeled in FIG. 7.

TABLE I
Average grain size for the top layer

| | 800 fs | 20 ps | 200 ps | | |
|---|---|---|---|---|---|
| | pulse | pulse | pulse | | Tungsten |
| | width | width | width | CW | Substrate |
| | sample | sample | sample | sample | Sample |
| Average grain | 564 | 855 | 1042 | 1109 | 1086 |
| size area (μm²) | | | | | |

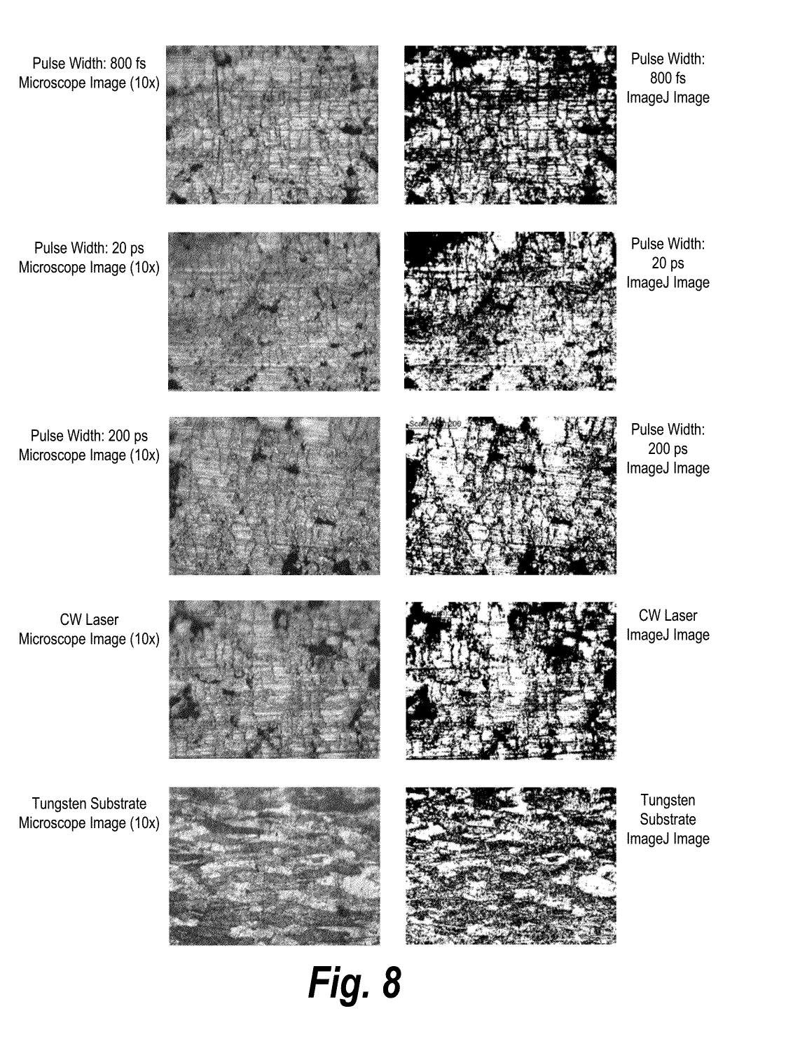

FIG. 8 shows microscope images at 10× of the cross section of a tungsten sample and their respective ImageJ images for pulse widths of 800 fs, 20 ps, 200 ps, CW, and the substrate, in accordance with some embodiments.

A 10× microscope image was also taken of the cross section of each of the samples described in FIG. 7 as well as of the tungsten substrate. The five 10× microscope images of the cross section are shown and labeled in FIG. 8. Using ImageJ, which is an open source image processing program, the boundaries and outlines of the grain sizes were highlighted and an average grain size area of the cross section was calculated. Table II lists the calculated average grain size area of the cross section for the different samples and the five 10× ImageJ images are shown and labeled in FIG. 8.

TABLE II
Average grain size for the cross section

| | 800 fs | 20 ps | 200 ps | | |
|---|---|---|---|---|---|
| | pulse | pulse | pulse | | Tungsten |
| | width | width | width | CW | Substrate |
| | sample | sample | sample | sample | Sample |
| Average grain | 595 | 700 | 1011 | 1135 | 827 |
| size area (μm²) | | | | | |

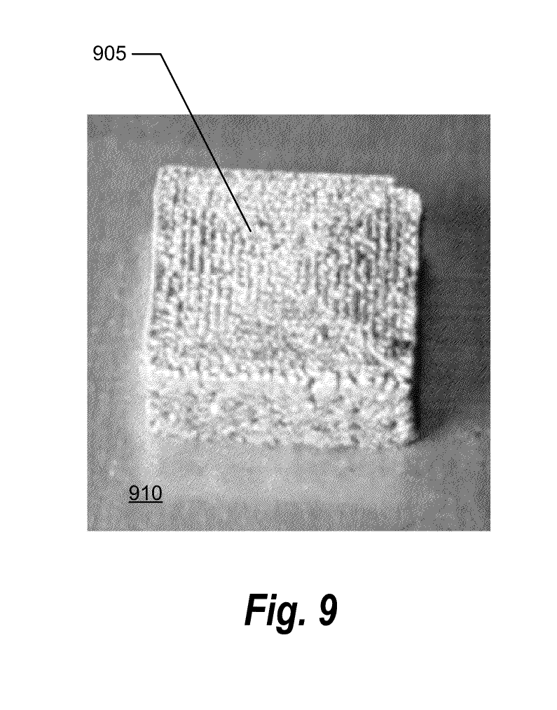

FIG. 9 is a photograph of a porous tungsten sample made from the apparatus for modifying microstructure and grain size in three-dimensional additive manufacturing of FIG. 3, FIG. 4, and FIG. 5, in accordance with some embodiments.

Using a pulse energy of 50 μJ, an additively manufactured tungsten sample results in a porous structure 905 as illustrated in FIG. 9. The tungsten structure 905 is strongly attached to the tungsten substrate 910.

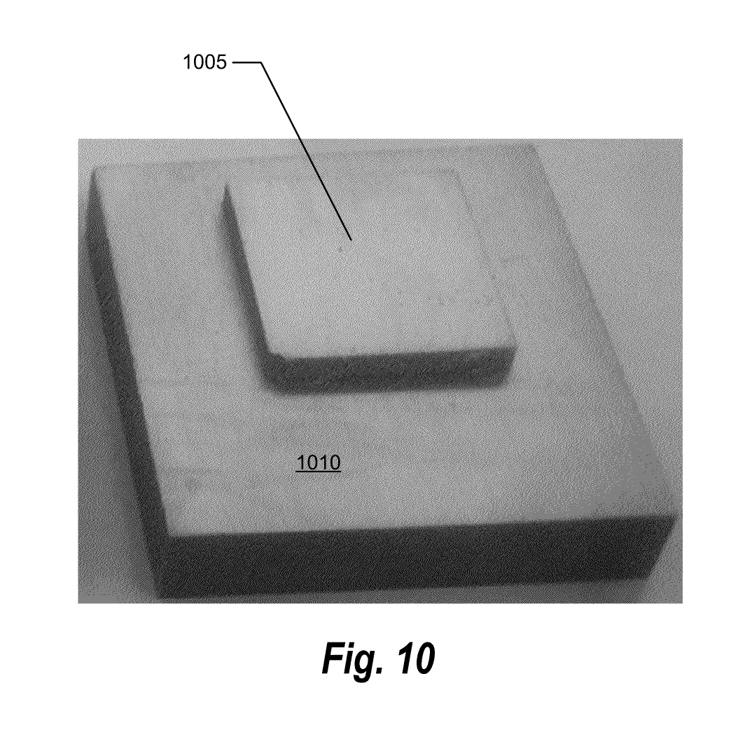

FIG. 10 is a photograph of a high density tungsten sample made from the apparatus for modifying microstructure and grain size in three-dimensional additive manufacturing of FIG. 3, FIG. 4, and FIG. 5, in accordance with some embodiments.

Using a pulse energy of 4 μJ, an additively manufactured tungsten sample results in a high density (99%) structure 1005 as illustrated in FIG. 10. The tungsten structure 1005 is strongly attached to the tungsten substrate 1010.

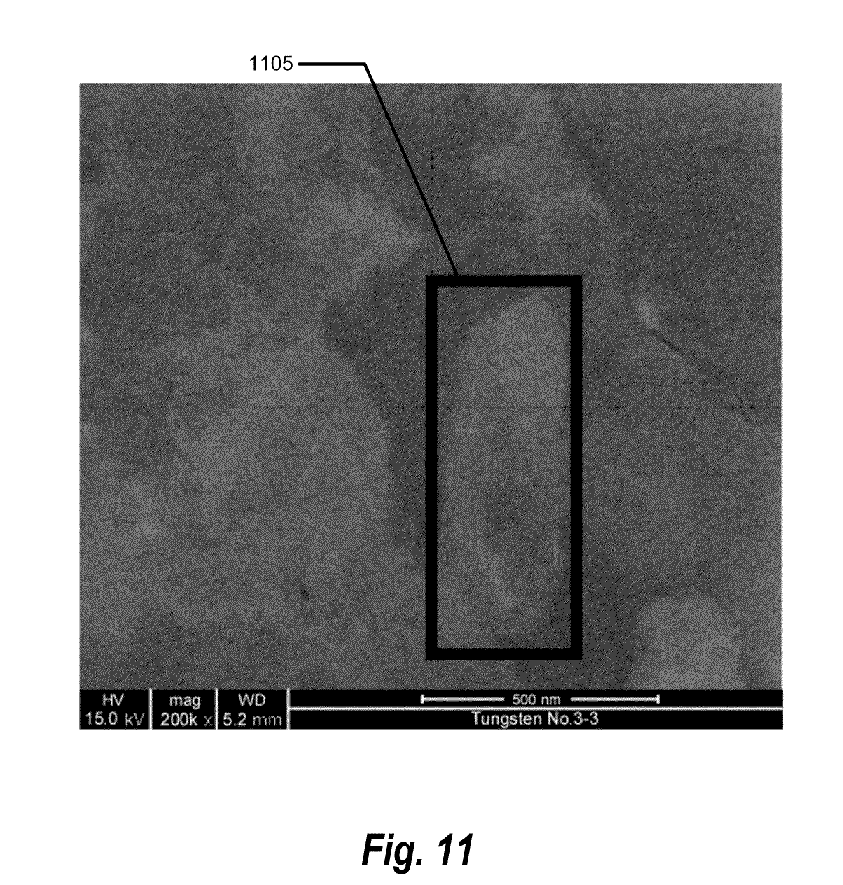

FIG. 11 is an SEM of the cross section of a tungsten sample made from the apparatus for modifying microstructure and grain size in three-dimensional additive manufacturing of FIG. 3, FIG. 4, and FIG. 5 resulting from selective laser melting of tungsten powder, in accordance with some embodiments.

FIG. 11 shows an SEM of the cross-section of the completely melted region of the formed shaped structure. A sub-micron grain as shown within region 1105 indicates that the tungsten powder has completely melted and been recrystallized. No voids or cracks are observed in the cross-section of the completely melted region. The uniform submicron grain size observed under SEM indicates that a strong bond results from using the high energy, high power ultrafast fiber laser at high PRR. This indicates by using appropriate laser parameters fine microstructures can be made.

The powder may comprise one or more different powder materials and their alloys or composition. The one or more different powder materials may comprise aluminum, steel, stainless steel, titanium, and the refractory metals, niobium, molybdenum, tantalum, tungsten, and rhenium. The one or more different powders may also comprise ceramics such as hafnium (Hf) and zirconium (Zr) based diboride (HfB₂ and ZrB₂), titanium carbide (TiC), titanium nitride (TiN), thorium dioxide (ThO₂), silicon carbide (SiC), tantalum carbide (TaC) and their associated composites. The one or more different powders may also comprise glasses and crystals such as fused silicon, BK7, quartz, diamond, grapheme, sapphire, and others. The one or more different powders may also comprise semiconductors such as silicon, germanium, GaAs, etc. The powder size of the material ranges from about 1 micron to 200 microns.

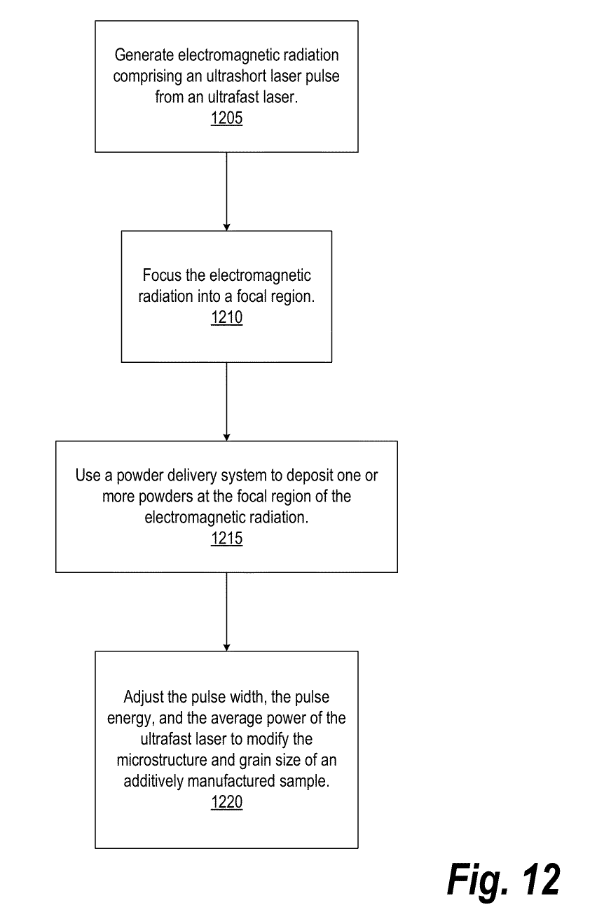

FIG. 12 is a block diagram illustrating a method for modifying microstructure and grain size in three-dimensional additive manufacturing, in accordance with some embodiments.

In some embodiments, processing begins at step 1205 where an ultrafast laser is used to generate an electromagnetic radiation comprising an ultrashort laser pulse. The ultrafast laser will have a PRR from about 0.1 MHz up to 1 GHz, an average power of about 1 to 2000 W, a pulse width of about 0.1 ps to 1 ns, an energy from about 0.1 μJ to 30 mJ, and a wavelength between about 0.2 to 3 μm. At step 1210, the electromagnetic radiation is focused into a focal region. Next, at step 1215, a powder delivery system is used to deposit one or more powders at the focal region of the electromagnetic radiation. Lastly, at step 1220, the pulse width, the pulse energy, and the average power of the ultrafast laser are adjusted to modify the microstructure and grain size of an additively manufactured sample. As the pulse width is increased, the average microstructure and grain size of the additively manufactured sample increases. As the pulse energy is decreased, the density of the additively manufactured sample increases.

The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

The benefits and advantages that may be provided by the present invention have been described above with regard to specific embodiments. These benefits and advantages, and any elements or limitations that may cause them to occur or to become more pronounced are not to be construed as critical, required, or essential features of any or all of the claims. As used herein, the terms “comprises,” “comprising,” or any other variations thereof, are intended to be interpreted as non-exclusively including the elements or limitations which follow those terms. Accordingly, a system, method, or other embodiment that comprises a set of elements is not limited to only those elements, and may include other elements not expressly listed or inherent to the claimed embodiment.

While the present invention has been described with reference to particular embodiments, it should be understood that the embodiments are illustrative and that the scope of the invention is not limited to these embodiments. Many variations, modifications, additions, and improvements to the embodiments described above are possible. It is contemplated that these variations, modifications, additions, and improvements fall within the scope of the invention as detailed within the following claims.

1. A method for modifying microstructure and grain size in three-dimensional additive manufacturing comprising:
generating electromagnetic radiation from an ultrafast laser, wherein the electromagnetic radiation comprises a wavelength, a pulse repetition rate, a pulse width, a pulse energy, and an average power;
focusing the electromagnetic radiation into a focal region;
using a powder delivery system to deposit one or more powders at the focal region of the electromagnetic radiation; and
adjusting the pulse width, the pulse energy, and the average power of the ultrafast laser to modify the microstructure and grain size of an additively manufactured sample.

2. The method of claim 1, wherein the average microstructure and grain size increases as the pulse width is increased.

3. The method of claim 1, wherein the density of the additively manufactured sample increases as the pulse energy is decreased.

4. The method of claim 1, wherein the powder delivery system comprises a powder vessel, a roller, and a receptacle and wherein the powder delivery system is configured to:
deposit one or more powders from the powder vessel into the receptacle at the focal region of the electromagnetic radiation; and
spread the one or more powders in the receptacle into a fabrication powder bed.

5. The method of claim 3, wherein the powder vessel comprises a powder delivery piston configured to raise the one or more powders above the lip of the powder vessel.

6. The method of claim 3, wherein the powder vessel comprises a hopper configured to drop the one or more powders into the receptacle.

7. The method of claim 3, wherein the receptacle comprises a fabrication piston configured to lower the fabrication powder bed.

8. The method of claim 1, wherein the one or more powders comprises at least one of aluminum, steel, stainless steel, titanium, niobium, molybdenum, tantalum, tungsten, rhenium, hafnium diboride, zirconium diboride, titanium carbide, titanium nitride, thorium dioxide, silicon carbide, tantalum carbide, fused silicon, BK7, quartz, diamond, graphene, sapphire, silicon, germanium, and gallium arsenide.

9. The method of claim 1, wherein the one or more powders comprises a powder size ranging from about 1 μm to about 200 μm.

10. The method of claim 1, wherein focusing the electromagnetic radiation comprises using a scanner to receive the electromagnetic radiation from the ultrafast laser and scanning within a scanning range the electromagnetic radiation onto the one or more powders.

11. The method of claim 1, further comprising using one or more stages to support the powder delivery system and to position the powder delivery system in one or more axis within the focus range of the electromagnetic radiation.

12. The method of claim 1, further comprising:
positioning a dichroic filter between the focusing mechanism and the focal region; and
focusing an imager and processor through the dichroic filter and onto the additively manufactured sample to monitor the additively manufactured sample within the focus range of the electromagnetic radiation.

13. The method of claim 1, wherein the ultrafast laser comprises at least one of a Yb doped fiber laser, an Er doped fiber laser, a Tm doped fiber laser, a Ho doped fiber laser, an Er:ZBLAN fiber laser, a KGW thin disk laser, and a KYW thin disk laser.

14. The method of claim 1, wherein the wavelength of the electromagnetic radiation generated from the ultrafast laser ranges from about 0.2 μm to 3 μm.

15. The method of claim 1, wherein the pulse repetition rate of the electromagnetic radiation generated from the ultrafast laser ranges from about 0.1 MHz to 1 GHz.

16. The method of claim 1, wherein the pulse width of the electromagnetic radiation generated from the ultrafast laser ranges from about 0.1 ps to 1 ns.

17. The method of claim 1, wherein the ultrafast laser operates CW.

18. The method of claim 1, wherein the pulse energy of the electromagnetic radiation generated from the ultrafast laser ranges from about 0.1 μJ to 30 mJ.

19. The method of claim 1, wherein the average power of the electromagnetic radiation generated from the ultrafast laser ranges from about 1 W to 2000 W.

20. The method of claim 1, wherein the electromagnetic radiation is polarized.

21. The method of claim 20, wherein the electromagnetic radiation is circularly polarized.

22. The method of claim 10, further comprising rotationally scanning on a micron scale the electromagnetic radiation onto the one or more powders.
